(19) United States
(12) Patent Application Publication
(10) Pub. No.: US 2014/0007904 A1
(43) Pub. Date: Jan. 9, 2014

(54) Cleaning of Solar Panels

(71) Applicants: Noam Shapira, Hod Hasharon (IL); Shmuel Glick, Kfar Saba (IL)

(72) Inventors: Noam Shapira, Hod Hasharon (IL); Shmuel Glick, Kfar Saba (IL)

(21) Appl. No.: 13/543,833

(22) Filed: Jul. 8, 2012

(51) Int. Cl. B08B 1/04; B08B 7/04

(52) U.S. Cl. 134/6; 15/246; 15/250.001

(57) ABSTRACT

A method for cleaning a surface that is deployed in an outdoor location includes mounting a wiper so as to traverse the surface along a predefined path in order to remove dirt from the surface. The wiper is driven to traverse the surface responsively to a difference between an ambient nighttime temperature and an ambient daytime temperature in the outdoor location.

### FIELD OF THE INVENTION

The present invention relates generally to devices and methods for surface cleaning, and particularly to autonomous cleaning devices.

### BACKGROUND

Dust and other sorts of dirt tend to accumulate on any exposed outdoor surface. In the case of solar panels, the dirt that accumulates on the transparent cover of the solar panel attenuates the solar radiation that impinges on the energy conversion elements (such as solar cells) in the panel, and thus reduces the efficiency of energy conversion. For this reason, maintenance personnel in many commercial solar power facilities regularly clean the panels; but this approach is labor-intensive and costly, and is inappropriate for many smaller installations.

A number of approaches have been proposed for automatic cleaning of solar panels. For example, U.S. Patent Application Publication 2010/0000570 describes a method for cleaning solar panels by means of a washing apparatus that can be displaced on the solar panel. The apparatus applies running water to the surface of the solar panel and washes the surface with the help of washing nozzles and/or brushes.

As another example, U.S. Patent Application Publication 2007/0240278 describes an automatic cleaning system that includes a pressure tank and a pressurizer, which is thermally coupled to the pressure tank. The pressurizer increases the pressure of air within the pressure tank based on transferring heat from absorbed solar energy to the air within the pressure tank. A release valve coupled to a jet directs expelled air from the pressure tank over the glass top of a solar panel for the purpose of automatic cleaning.

Shape memory materials are alloys that “remember” an original, pre-deformed shape and return to the shape when they are heated after being deformed. Common shape memory materials include NiTi (also known as Nitinol), as well as CuAlNi and other alloys. When a shape-memory alloy is in its cold, martensitic state, the metal can be bent or stretched and will then hold its current shape until heated above a certain transition temperature. Upon heating, the alloy is transformed to an austenitic state, in which its shape returns to its original, pre-deformed shape. The transition temperature of a shape memory alloy (as well as its shape) is determined by the manufacturing process.

Shape memory materials are used in a variety of applications, including as heat-driven motion actuators. For example, U.S. Pat. No. 6,915,633 describes shape memory actuators for use with repetitive motion devices. In one embodiment, such an actuator urges a blade end of a wiper arm towards a non-opaque surface of a motor vehicle and moves the blade end of the wiper arm over the non-opaque surface.

### SUMMARY

Embodiments of the present invention that are described hereinbelow provide improved devices and methods for cleaning dirt from surfaces, such as solar panels.

There is therefore provided, in accordance with an embodiment of the present invention, a device for cleaning a surface that is deployed in an outdoor location. The device includes a wiper, which is mounted so as to traverse the surface along a predefined path in order to remove dirt from the surface. An actuator, which includes a shape-memory element having an austenitic state and a martensitic state, with a temperature of transition between the martensitic and austenitic states that is in a range between an ambient nighttime temperature and an ambient daytime temperature in the outdoor location, is coupled to the wiper so that the transition of the shape-memory element from the martensitic to the austenitic state causes the wiper to traverse the surface.

In a disclosed embodiment, the shape-memory element includes a flexible, elongate member, which is stretched while in the martensitic state and contracts in the transition to the austenitic state, and contraction of the shape-memory element causes the wiper to traverse the surface. The actuator may include an elastic member, which is coupled to stretch the elongate member while in the martensitic state.

In one embodiment, the actuator includes a hinge, about which the wiper rotates while traversing the surface, and the shape-memory element is coupled to the hinge so that the transition from the martensitic to the austenitic state causes the wiper to rotate about the hinge.

Typically, the actuator is configured to operate in response to ambient heat in the outdoor location and causes the wiper to traverse the surface without application of electrical energy to the actuator.

In a disclosed embodiment, the wiper is configured to clean the surface of a solar panel. Additionally or alternatively, the device includes a compartment mounted at an end of the path and configured to contain the wiper.

There is also provided, in accordance with an embodiment of the present invention, a method for cleaning a surface that is deployed in an outdoor location. The method includes mounting a wiper so as to traverse the surface along a predefined path in order to remove dirt from the surface. The wiper is driven to traverse the surface responsively to a difference between an ambient nighttime temperature and an ambient daytime temperature in the outdoor location.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a solar energy system with automated cleaning, in accordance with an embodiment of the present invention; and

FIG. 2 is a schematic, frontal view of a solar panel with an automatic cleaning device, in accordance with an embodiment of the present invention.

### DETAILED DESCRIPTION OF EMBODIMENTS

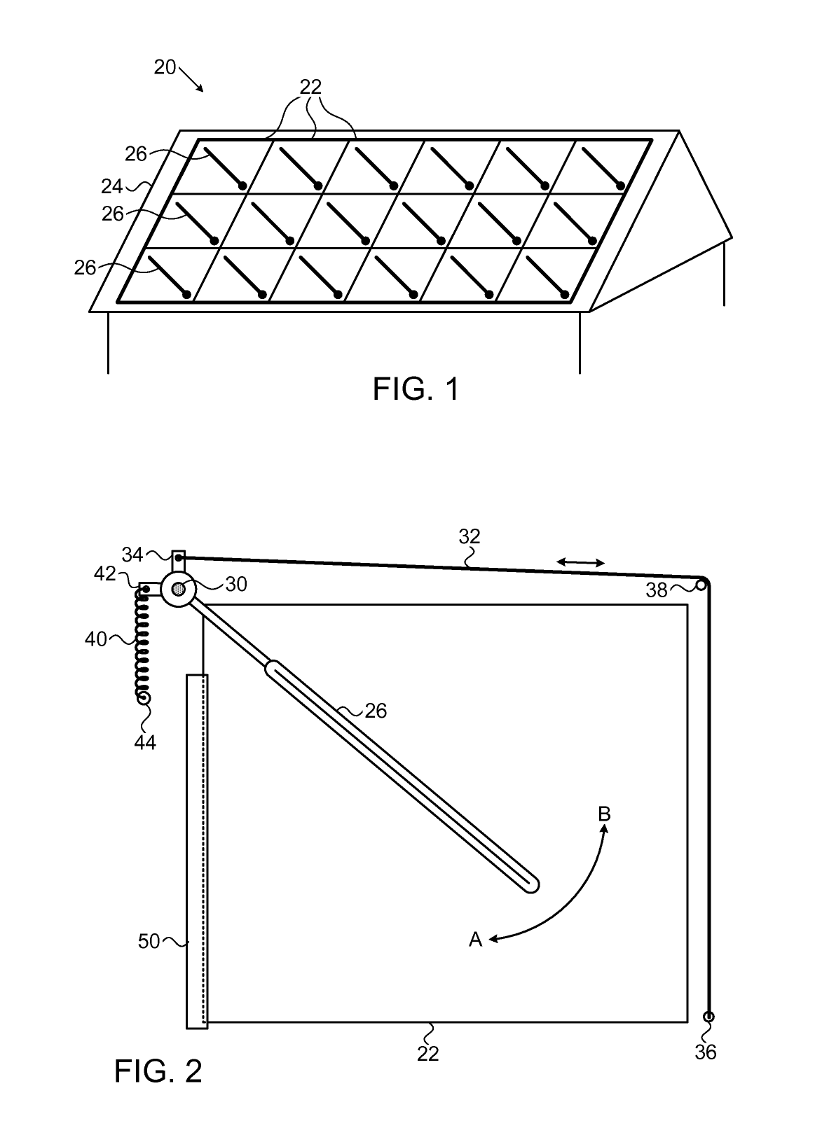

FIG. 1 is a schematic, pictorial illustration of a solar energy system 20 with automated cleaning, in accordance with an embodiment of the present invention. The system comprises multiple solar panels 22, which in this example are mounted on the roof of a structure 24. The panels may be of any suitable type that is known in the art for conversion of solar energy to electricity or other energy forms. Although the panels are shown in this example on a roof, they may be mounted in any outdoor environment and in any suitable configuration that is known in the art. (The rooftop deployment, however, is particularly illustrative of the difficulty that may be encountered in cleaning the panels.)

The upper surface of each solar panel 22 is a transparent, protective cover. In order to remove dirt that accumulates on the surface of this cover, each panel is equipped with a wiper 26, which periodically traverses the surface along a predefined path. In the pictured examples, the wiper is mounted to rotate along this path about a hinge. Alternatively, the wiper may be mounted to move linearly over the panel. Further alternatively or additionally, each panel may be equipped with multiple wipers, and in this manner the overall area that is cleaned may be increased.

As explained in greater detail hereinbelow, wipers 26 are actuated using a shape-memory element, which causes the wipers to traverse their paths in response to ambient heat in the outdoor location in which panels 22 are deployed. The wipers are thus able to traverse the surface of the respective panels without application of electrical energy to actuate them. As the shape-memory elements warm in the morning, they cause the wipers traverse the panels in one direction, so that the wipers may use the dew that naturally deposits on the panels during the night as a cleaning fluid. When the shape-memory elements cool at night, the wipers return to their original positions (due, for example, to the operation of an elastic element as shown below, or to an alternative return mechanism, such as a counterweight or two-way shape memory operation). Thus, wipers 26 are capable of cleaning panels 22 daily without any expenditure of energy or cleaning materials.

FIG. 2 is a schematic, frontal view of solar panel 22 with an automatic cleaning device, in accordance with an embodiment of the present invention. As noted earlier, wiper 26 rotates about a hinge 30. In this example, the wiper comprises a single arm, which is typically fitted with one or more rubber blades that remove fluid and dirt from the surface of the panel as the wiper traverses the surface. In alternative embodiments, the wiper may also comprise other cleaning elements, such as a brush to scrub the dirt ahead of the blade and a drying fabric following the blade. These elements may be mounted together on a single wiper arm, or they be mounted on separate wiper arms, which may be moved by the same actuator or different actuators. A fluid dispenser (not shown) may also be provided in order to wet the panel surface when dew is absent.

Wiper 26 is actuated by a flexible, elongate shape-memory element 32, which is coupled between an actuator arm 34 on hinge 30 and an anchor 36. In this embodiment, element 32 comprises a shape-memory wire, tube, or ribbon, which can be stretched while in the martensitic state and contracts in the transition to the austenitic state. Typically, element 32 comprises a NiTi alloy, but other shape-memory materials that are known in the art may alternatively be used. To increase the length of element 32, and thus the amount of contraction, element in the pictured embodiment turns around a pivot 38. Additionally or alternatively, element 32 may be wound back and forth between arm 34 and anchor 36 two or more times.

An elastic member, such as a spring 40, is coupled between a return arm 42 on hinge 30 and a spring anchor 44. The spring exerts an opposing (but weaker) force to the austenitic contraction of element 32. Thus, as the environment of panel 22 warms past the transition temperature of the shape-memory material in element 32, contraction of the shape-memory element causes wiper 26 to traverse the surface of panel 22 in the direction marked “A” in the figure. When the environment cools, shape-memory element 32 returns to its martensitic state, in which spring 40 is able to stretch element 32 and thus return wiper in direction “B” to its original position.

The transition temperature of shape-memory element 32, between the martensitic and austenitic states, is determined by the manufacturing process and can be adjusted by a method of trial and error, as will be familiar to those skilled in the art. The transition temperature is typically chosen to be in the range between the ambient nighttime and daytime temperatures in the location in which panel 22 is to be deployed. In warm, temperate climates, for example, the transition temperature may be set to about 15° C., so that the transition to the austenitic state will generally take place during the morning hours, while the panel is still damp from dew. At night, when the temperature drops, spring 40 will return the wiper to its initial position, so that the wiper generally traverses one full cycle every day.

Alternatively, the transition temperature of shaper-memory element 32 may be set higher or lower, depending on the operating environment and other application requirements. Optionally, shape-memory element 32 may be replaced seasonally, so that an element with a higher transition temperature is used in the summer, and another element with a lower transition temperature is used in the winter.

As another option, a covered compartment 50 may be fixed at one side of panel 22, typically the side where wiper 26 rests during the daytime. Compartment 50 may then serve two functions: (1) to protect wiper 26 from deterioration due to solar radiation, and (2) to collect liquid (such as dew) that is swept across the panel by the wiper, for possible reuse on the return stroke. Alternatively or additionally, a covered compartment of this sort may be fixed at the side of panel 22 where wiper 26 rests during the nighttime.

In alternative embodiments (not shown in the figures), the wiper and shape memory element may have different configurations, while still implementing the principles outlined above. For example, as noted earlier, the wiper may traverse panel 22 along a linear path, possibly actuated by two shape-memory elements, one on either side. The shape-memory element (or elements) may also have different shapes and functional characteristics. For example, the shape-memory element may have the form of a spring or a sheet of shape-memory material. As another example, a two-way shape-memory material may be used, which alternates between high- and low-temperature shapes and thus moves the wiper both forward and back without the need for an elastic member (such as spring 40) or other return mechanism. All such alternative implementations, which make use of ambient heat and a shape-memory actuator to clean a panel, are considered to be within the scope of the present invention.

Although the embodiments described hereinabove use a shape memory element to drive wiper 26, in alternative embodiments (not shown in the figures) other mechanisms may be used to drive the wiper to traverse the surface in response to the difference between ambient nighttime and daytime temperatures. Like the above embodiment, these alternative embodiments use energy derived from ambient heat in the outdoor location of panel 22 to drive the wiper, and typically require no application of electrical energy. For example, the motion of the wiper may be driven by expansion of a gas as it is heated or by a heat-driven phase change or a heat-driven motor.

Furthermore, although the embodiment shown in FIG. 1 is directed specifically to cleaning of solar panels, the principles of the present invention may similarly be applied to cleaning surfaces of other sorts, such as windows, that are deployed in outdoor environments. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A device for cleaning a surface that is deployed in an outdoor location, the device comprising:
a wiper, which is mounted so as to traverse the surface along a predefined path in order to remove dirt from the surface; and
an actuator, which comprises a shape-memory element having an austenitic state and a martensitic state, with a temperature of transition between the martensitic and austenitic states that is in a range between an ambient nighttime temperature and an ambient daytime temperature in the outdoor location, and which is coupled to the wiper so that the transition of the shape-memory element from the martensitic to the austenitic state causes the wiper to traverse the surface.

2. The device according to claim 1, wherein the shape-memory element comprises a flexible, elongate member, which is stretched while in the martensitic state and contracts in the transition to the austenitic state, and wherein contraction of the shape-memory element causes the wiper to traverse the surface.

3. The device according to claim 2, wherein the actuator comprises an elastic member, which is coupled to stretch the elongate member while in the martensitic state.

4. The device according to claim 1, wherein the actuator comprises a hinge, about which the wiper rotates while traversing the surface, and wherein the shape-memory element is coupled to the hinge so that the transition from the martensitic to the austenitic state causes the wiper to rotate about the hinge.

5. The device according to claim 1, wherein the actuator is configured to operate in response to ambient heat in the outdoor location.

6. The device according to claim 5, wherein the actuator is configured to cause the wiper to traverse the surface without application of electrical energy to the actuator.

7. The device according to claim 1, wherein the wiper is configured to clean the surface of a solar panel.

8. The device according to claim 1, and comprising a compartment mounted at an end of the path and configured to contain the wiper.

9. A method for cleaning a surface that is deployed in an outdoor location, the method comprising:
mounting a wiper so as to traverse the surface along a predefined path in order to remove dirt from the surface; and
driving the wiper to traverse the surface responsively to a difference between an ambient nighttime temperature and an ambient daytime temperature in the outdoor location.

10. The method according to claim 9, wherein driving the wiper comprises:
providing a shape-memory element having an austenitic state and a martensitic state, with a temperature of transition between the martensitic and austenitic states that is in a range between the ambient nighttime temperature and the ambient daytime temperature in the outdoor location; and
coupling the shape-memory element to the wiper so that the transition of the shape-memory element from the martensitic to the austenitic state causes the wiper to traverse the surface.

11. The method according to claim 10, wherein the shape-memory element comprises a flexible, elongate member, which is stretched while in the martensitic state and contracts in the transition to the austenitic state, and wherein contraction of the shape-memory element causes the wiper to traverse the surface.

12. The method according to claim 9, wherein mounting the wiper comprises coupling the wiper to a hinge, about which the wiper rotates while traversing the surface, and wherein driving the wiper causes the wiper to rotate about the hinge.

13. The method according to claim 9, wherein driving the wiper comprises applying to the wiper energy derived from ambient heat in the outdoor location.

14. The method according to claim 13, wherein the energy derived from the ambient heat causes the wiper to traverse the surface without application of electrical energy.

15. The method according to claim 13, wherein driving the wiper comprises applying the energy so as to cause the wiper to traverse the surface in a first direction during the daytime, and comprising coupling an elastic member to return the wiper in a second direction during the nighttime.

16. The method according to claim 9, wherein mounting the wiper comprises configuring the wiper to clean the surface of a solar panel.
